(19) United States
(12) Patent Application Publication
(10) Pub. No.: US 2006/0080839 A1
(43) Pub. Date: Apr. 20, 2006

(54) Shaving device having multiple razor blades

(76) Inventor: Mark Richard Hesketh, Leeds (GB)

Correspondence Address: POSS LIMITED, 35 HOLLY PARK, HUBY, LEEDS, LS17 0BT, GB

(21) Appl. No.: 11/163,093

(22) Filed: Oct. 5, 2005

(30) Foreign Application Priority Data
Oct. 14, 2004 (GB) GB 2411141 A

(51) Int. Cl. B26B 21/00

(52) U.S. Cl. 30/50

(57) ABSTRACT

A shaving device having multiple razor blades 1 that is composed of an assembly of razor cartridges 4, each razor cartridge having at least one razor blade, the assembly having two or more detachable and physically interchangeable cartridges. This arrangement enables the user to disengage the razor cartridges and so exchange the front mounted razor cartridge with the razor cartridge aft of it. The shaving device may be composed of a handle 2 with a connection end 3 to which attaches the assembly of razor cartridges 4.

The present invention pertains in general to shaving devices, and in particular, to shaving devices having multiple razor blades.

Modern shaving devices commonly have one or more blades retained within a cartridge that is mounted upon a handle. This cartridge may be detachably mounted to the handle, enabling replacement of a used cartridge. Many configurations for the method of mounting the cartridge to the handle exist, but typically there is a hand operable polymeric spring clip at the connection end of the handle that is used to detachably retain the cartridge.

The cartridge is typically composed of a plastic housing into which are mounted one or more razor blades. A cartridge with multiple razor blades usually presents a repetitive material, shape and finish of the cutting edge of each of the blades, these being essentially parallel to the direction of shaving and at a distance from each other. The said plastic housing is usually comprised of a seat portion to which the blade(s) is mounted, and a clip engagement portion for mating to the said clip at the connection end of the handle. The seat portion may be composed of a flexible structure to enable the razor blade(s) to accommodate their position against the surface being shaved, the razor blade(s) thus being movable lying in the blade plane. Additionally the cartridge may have a fore guard substantially sited adjacent to the leading edge of the first razor blade contacted by the surface to be shaved during shaving action and a cap portion substantially sited aft of the last of the razor blade(s). The fore guard position being that element of the cartridge which first contacts the surface to be shaved prior to contact with the razor blade(s). The aft location of the cap portion usually being so orientated that in conjunction with the location of the fore guard it defines the general attitude of the working edge of the razor blade(s) relative to the surface being shaved.

A characteristic of shaving devices with multiple razor blades is that the first blade contacted during shaving action has the primary cutting action work, this is generally of a greater abrasive load than the blade(s) aft of it that consequently has a lesser amount of abrasive work. The first blade therefore generally wears with use at a greater rate than the blade(s) that are seated aft of it. As the first blade progressively wears then the user is subject to an accumulating degradation in the thoroughness and smoothness of shaving, as a consequence, the user eventually selects to replace the whole cartridge. This defines a typical lifecycle of a cartridge in the modern razor with multiple razor blades, from a new cartridge to a used worn cartridge.

A disadvantage of the prior art for shaving devices with multiple razor blades is where the first razor blade has worn beyond satisfactory use and the razor blade(s) aft of it have remained comparatively usable, but there is no provision made for first blade substitution with a used, though lesser worn blade aft of it.

Based on the foregoing, it is the general object of the present invention to provide a multiple blade razor that improves over or overcomes the disadvantage of the prior art.

According to the present invention there is provided a shaving device having multiple razor blades where the shaving component is an assembly of two or more detachable and physically interchangeable razor cartridges with each razor cartridge having at least one razor blade.

Embodiments of the present invention will now be described, by way of example only, with reference to the accompanying drawings in which;

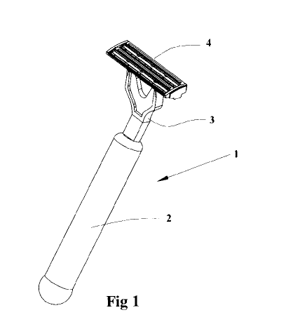

FIG. 1 is an above view of a modern razor with a plurality of blades retained within an assembly of razor cartridges that is mounted upon a handle.

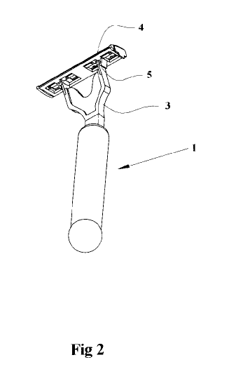

FIG. 2 is an underside view of a modern razor with a plurality of blades retained within an assembly of razor cartridges that is mounted upon a handle.

FIG. 3 is an above view of the cartridge support tray with provision for the mounting of two razor cartridges.

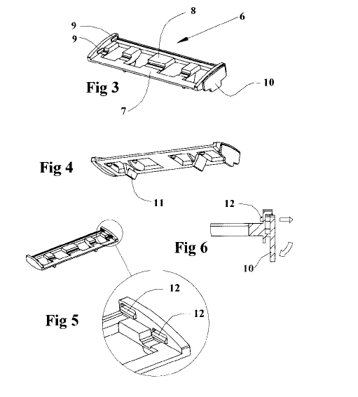

FIG. 4 is an underside view of the cartridge support tray.

FIG. 5 is a detail view of the cartridge support tray to show the sprung locators for retention of the razor cartridges.

FIG. 6 is a cross-sectional detail view of the flange used when detaching the razor cartridges.

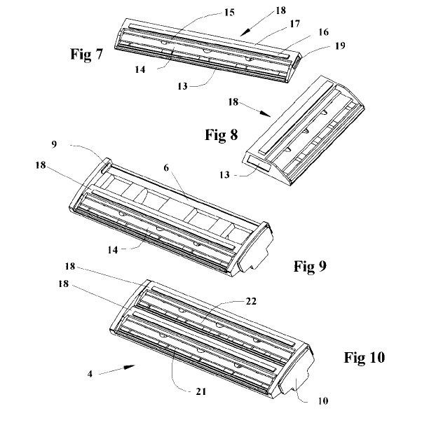

FIG. 7 is an above view of a razor cartridge.

FIG. 8 is a side view of a razor cartridge.

FIG. 9 is a an above of a razor cartridge mounted in the front location of the cartridge support tray.

FIG. 10 is an above view of two razor cartridges mounted in the cartridge support tray thereby forming a complete assembly of razor cartridges.

FIG. 1 shows how a shaving device having multiple razor blades 1 according to the present invention may be composed of a handle 2 with a connection end 3 of the handle 2 to which attaches the assembly of razor cartridges 4.

Referring to FIG. 2 the connection end 3 is typically made from a polymer selected to have an inherent sprung action for a hand operable polymeric spring clip 5 that is commonly used to detachably retain a razor cartridge and in this embodiment is used to detachably retain the assembly of razor cartridges 4.

The FIGS. 3 to 6 show various detail of one particular embodiment of the cartridge support tray 6 to which may be mounted two razor cartridges, this consequently forming the assembly of razor cartridges 4.

Referring to FIG. 3 the cartridge support tray 6 has one lower surface 7 to support the razor cartridge that carries the first blade used for shaving action, not just that of the razor cartridge but of the assembly of razor cartridges 4. The adjacent upper surface 8 is for the support of the razor cartridge aft of the razor cartridge that carries the first blade used for shaving action. The relative displacement and angularity between lower surface 7 and upper surface 8 is pre-determined so that the razor blade(s) mounted in each razor cartridge initially present to the surface to be shaved a set of cutting edges pre-defined by relative location, height and attitude. For a shaving device having multiple razor blades 1 where in total there are three or more razor blades then commonly the initial location of all the cutting edges is for them to lie in the same plane.

FIG. 4 shows the form of a clip engagement portion 11 as commonly used shaving device with multiple razor blades 1 for attachment to connection end 3 of the handle 2. The cartridge support tray 6 is therefore detachably mounted via the connection end 3 to the handle 2 of the shaving device.

Referring to FIG. 3 and FIGS. 5 to 6 for retention of the razor cartridges in the cartridge support tray 6 one embodiment is to have locking pegs 9 and opposed locking pegs 12 that may engage into the razor cartridges.

FIG. 5 has a detail view of the opposed locking pegs 12 protruding into the area where the razor cartridges are to be mounted.

FIG. 6 shows in sectional part view how the opposed locking pegs 12 may be temporarily disengaged from the razor cartridges by pressing upon the flange 10, the flange 10 is attached to or configured from the same polymer as the opposed locking pegs 12 and the cartridge support tray 6. It would be a consequence of pressing on the flange 10 that it should temporarily deform and effect a rotation about the side of the cartridge support tray 6 thereby drawing out of the opposed locking pegs 12. This arrangement for this embodiment of the present invention would enable the user to disengage the razor cartridges and so exchange the front mounted razor cartridge with the razor cartridge aft of it.

Conceivably the cartridge support tray 6 may be configured to take more than two razor cartridges.

Conceivably the cartridge support tray 6 could be fixedly attached to the connection end 3 of the handle 2, negating any requirement for the clip features of the hand operable polymeric spring clip 5 and the clip engagement portion 11.

The FIG. 7 shows detail of one particular embodiment of the razor cartridge 18 that may be detachably mounted in the cartridge support tray 6, it being according to the present invention that at least two razor cartridges are mounted to provide a shaving device with multiple razor blades 1 where the razor cartridges are physically interchangeable. The razor cartridge 18 in this particular embodiment has two razor blades, a fore blade 14 and an aft blade 15. Adjacent to the fore blade 14 is the fore guard 13 whose function is to prepare the surface to be shaved just prior to contacting the fore blade 14. The fore guard 13 is shown with a ribbed surface and may be moulded from a more compliant elastomer, such as a Silicone rubber, or a more compliant polymer, such as a low density Polyurethane, than that of the usually injection moulded polymer of body 17 of the razor cartridge 18. Adjacent to and partially behind the aft blade 15 is located the cap portion 16, this item may be bonded by adhesive to the body 17 and provides a porous fabric which may be impregnated with an emolument compound, the scope of which is not detailed in this invention. At either side of the body 17 there is an indent, that of the latching side indent 19 is shown in FIG. 7. For a mounted razor cartridge 17 the latching side indent 19 interlocks with the opposed locking pegs 12 as shown in FIG. 5 and FIG. 6.

The FIG. 8 shows detail of the non-latching side indent 20 in the opposite side of the body 17.

The FIG. 9 shows detail of the razor cartridge 18 detachably mounted in the cartridge support tray 6, the retaining features are by way of one of the locking pegs 9 engaging in the non-latching side indent 20 and one of the opposed locking pegs 12 engaging in latching side indent 19. FIG. 9 also shows the razor cartridge 18 detachably mounted on the lower surface 7 of the cartridge support tray 6 giving it's fore blade 14 the temporary role of the first cutting blade of the assembly of razor cartridges 4.

The FIG. 10 shows detail of the assembly of razor cartridges 4, wherein two razor cartridge 18 are mounted in the cartridge support tray 6, a second razor cartridge 4 having been mounted this time upon upper surface 8. This assembly of razor cartridges may then be attached to the connection end 3 of the razor handle 2, by way of it's clip engagement portion 11, so forming the complete modern razor with multiple razor blades whose first cutting edge 21 may at the user's volition be substituted by the aft blade cutting edge 22.

Conceivably the latching arrangement of the razor cartridge 18 to the cartridge support tray 6 may be by means other than those of sprung clip form as disclosed in this embodiment. Alternative latching arrangements may include, but not be exclusively limited to, other spring clip forms, magnetic locks, bolt catches, pins, screws, rivets and similar forms of detachable mechanical interference.

Conceivably the razor cartridge 18 may be composed of just one razor blade fulfilling the functional requirements of the fore blade 14.

Conceivably the razor cartridge 18 has no fore guard 14.

Conceivably the razor cartridge 18 has no cap portion 16.

Conceivably the assembly of razor cartridges 4 may be formed by the razor cartridge 18 having mutually interconnecting features such that two or more razor cartridge 18 detachably lock together without recourse to use of a cartridge support tray 6.

Conceivably the connection end 3 of a modern razor having multiple razor blades 1 may concurrently attach directly to two or more razor cartridge 18, the attachment being by detachable means, such that the assembly of razor cartridges 4 may be formed by two or more razor cartridge 18 without recourse to use of a cartridge support tray 6.

What is claimed is:

1. A shaving device having multiple razor blades where the shaving component is an assembly of two or more detachable and physically interchangeable razor cartridges with each razor cartridge having at least one razor blade.

2. A shaving device having multiple razor blades where the shaving component is an assembly of two detachable and physically interchangeable razor cartridges with each razor cartridge having at least one razor blade.

3. A shaving device having multiple razor blades where the shaving component is an assembly of two or more detachable and physically interchangeable razor cartridges with each razor cartridge having more than one razor blade.

4. A shaving device having multiple razor blades where the shaving component is an assembly of two detachable and physically interchangeable razor cartridges with each razor cartridge having more than one razor blade.

5. A shaving device as claimed in any preceding claim where the assembly of razor cartridges is composed of razor cartridges detachably mounted to a cartridge support tray.

6. A shaving device as claimed in claim 5 where the cartridge support tray is detachably mounted to the handle of the shaving device.

7. A shaving device as claimed in claim 5 where the cartridge support tray is fixedly mounted to the handle of the shaving device.

8. A shaving device as claimed in any one of claims 5 to 7, where the means for detachably retaining the razor cartridges to the support tray is by sprung peg.

9. A shaving device as claimed in any one of claims 5 to 7, where the means for detachably retaining the razor cartridges to the support tray is by magnetic lock A shaving device as claimed in any one of claims 5 to 7, where the means for detachably retaining the razor cartridges to the support tray is by detachable mechanical interference.

10. A shaving device as claimed in any one of claims 1 to 4 where the razor cartridge has mutually interlocking features such that the assembly of razor cartridges may be formed by two or more razor cartridge.

11. A shaving device as claimed in any one of claims 1 to 4 where the connection end of the shaving device may concurrently attach directly to two or more razor cartridge.

12. A shaving device as claimed in any preceding claim where the cartridge has a fore guard.

13. A shaving device as claimed in any preceding claim where the cartridge has a cap portion.

14. A shaving device having multiple razor blades substantially as described herein with reference to FIGS. 1 to 10 of the accompanying drawings.
